(19) United States
(12) Patent Application Publication
(10) Pub. No.: US 2024/0391634 A1
(43) Pub. Date: Nov. 28, 2024

(54) RFID ENABLED STORAGE ASSEMBLIES AND PROCESSES FOR MANUFACTURE THEREOF

(71) Applicant: Polymer Solutions International Inc., Medford, NJ (US)

(72) Inventors: Gerald Koefelda, Lake Bluff, IL (US); John A. Spadavecchia, Atlantic Beach, NC (US); Walter T. Blanchard, Alamo Heights, TX (US); Daniel E. Kelly, Medford, NJ (US)

(73) Assignee: Polymer Solutions International Inc., Medford, NJ (US)

(21) Appl. No.: 18/672,729

(22) Filed: May 23, 2024

Related U.S. Application Data
(60) Provisional application No. 63/469,171, filed on May 26, 2023.

(51) Int. Cl. B65D 1/02; B65D 23/10; B65D 23/14; G06K 19/077

(52) U.S. Cl. CPC B65D 1/0207; B65D 23/104; B65D 23/14; G06K 19/07758; B65D 2203/10; B65D 2501/0009

(57) ABSTRACT

A storage assembly includes a container having an attachment surface and a handle or handle assembly that is positionable adjacent the attachment surface. The handle comprises an elongated grip portion, an anchor for mounting the handle to the attachment surface, and at least one electronic component configured for at least wireless identification or tracking of the container. The at least one electronic component is partially or entirely encapsulated in the handle. A method of integrating an electronic component to a handle provided for attachment to a container includes the steps of: (a) providing at least one electronic component; (b) molding a molding material about the at least one electronic component to form a molded electronic component assembly; (c) forming a handle including the molded electronic component assembly; and (d) removably mounting the handle to the container.

### CROSS-REFERENCE TO RELATED APPLICATIONS

This application claims priority from U.S. Provisional Application Ser. No. 63/469,171, titled RFID ENABLED STORAGE ASSEMBLIES AND PROCESSES FOR MANUFACTURE THEREOF, filed May 26, 2023, incorporated herein by reference in its entirety for all purposes.

### FIELD

The present disclosure relates generally to storage assemblies, and more specifically to storage assemblies comprising a container, such as a bottle assembly, which include a handle having at least one electronic component configured for at least wireless identification or tracking of the container (e.g. radio frequency identification (RFID) tag).

### BACKGROUND

Incorporation of RFID tracking capability with containers is useful for consistent tracking of containers throughout their usable life. Currently, the traceability of bottle assemblies, such as water bottles, is limited. Traceability of these container may be useful to quantify their usable life and determine whether and to what extent their usable life may be affected during distribution, transport, and end-use handling.

### SUMMARY OF THE INVENTION

Aspects of the present invention are directed to RFID enabled storage assemblies and processes for manufacture thereof.

In accordance with one aspect of the present invention, a storage assembly is disclosed. The storage assembly comprises a container having an attachment surface. The storage assembly also includes a handle that is positionable adjacent the attachment surface. The handle comprises an elongated grip portion, an anchor for mounting the handle to the attachment surface, and at least one electronic component configured for at least wireless identification or tracking of the container. The at least one electronic component is partially or entirely encapsulated in the handle.

In accordance with another aspect of the present invention, a handle assembly configured to be coupled to a container having an attachment surface is disclosed. The handle assembly comprises an elongated grip portion; an anchor for mounting the handle assembly to the attachment surface of the container; and at least one electronic component configured for at least wireless identification or tracking of the container. The at least one electronic component is partially or completely encapsulated in the handle assembly.

In accordance with yet another aspect of the present invention, a method of integrating an electronic component to a handle provided for attachment to a container is disclosed. The electronic component is configured for at least wireless identification or tracking of the container. The method comprises the steps of: (a) providing at least one electronic component; (b) molding a molding material about the at least one electronic component to form a molded electronic component assembly; (c) forming a handle including the molded electronic component assembly; and (d) mounting the handle to the container.

### BRIEF DESCRIPTION OF THE DRAWING FIGURES

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 depicts an exemplary storage assembly comprising a container and handle, according to one example;

FIG. 2A is a top view of an exemplary handle assembly having at least one RFID tag incorporated in an exemplary location, according to one example;

FIG. 2B is a front view of the handle assembly of FIG. 2A;

FIG. 2C is a side view of the handle assembly of FIG. 2A;

FIG. 3A is a top view of an exemplary handle assembly having at least one RFID tag incorporated in an exemplary location, according to one example;

FIG. 3B is a front view of the handle assembly of FIG. 3A;

FIG. 3C is a side view of the handle assembly of FIG. 3A;

FIG. 4A is a top view of an exemplary handle assembly having at least one RFID tag incorporated in an exemplary location, according to one example;

FIG. 4B is a front view of the handle assembly of FIG. 4A;

FIG. 4C is a side view of the handle assembly of FIG. 4A;

FIG. 5A is a bottom view of an exemplary handle assembly having at least one RFID tag incorporated in an exemplary location, according to one example;

FIG. 5B is a front view of the handle assembly of FIG. 5A;

FIG. 5C is a side view of the handle assembly of FIG. 5A;

FIG. 6A is a bottom view of an exemplary handle assembly having at least one RFID tag incorporated in an exemplary location, according to one example;

FIG. 6B is a front view of the handle assembly of FIG. 6A;

FIG. 6C is a side view of the handle assembly of FIG. 6A;

FIG. 7A is a bottom view of an exemplary handle assembly having at least one RFID tag incorporated in an exemplary location, according to one example;

FIG. 7B is a front view of the handle assembly of FIG. 7A;

FIG. 7C is a side view of the handle assembly of FIG. 7A;

FIG. 8A is a bottom view of an exemplary handle assembly having at least one RFID tag incorporated in an exemplary location, according to one example;

FIG. 8B is a front view of the handle assembly of FIG. 8A;

FIG. 8C is a side view of the handle assembly of FIG. 8A;

FIG. 9A depicts an exemplary handle assembly having at least one RFID tag incorporated in an exemplary location, according to one example;

FIG. 9B is a front view of the handle assembly of FIG. 9A;

FIG. 10A is an isometric view of an exemplary handle assembly having at least one RFID tag incorporated in an exemplary location, according to one example;

FIG. 10B is a side view of the handle assembly of FIG. 10A;

FIG. 10C is a detailed view of the handle assembly of FIG. 10A;

FIG. 11A is a detailed view of an exemplary handle assembly having at least one RFID tag incorporated in at least one exemplary location, according to one example;

FIG. 11B is an isometric view of the handle assembly of FIG. 11A;

FIG. 12 depicts an exemplary method of integrating at least one electronic component to a handle provided for attachment to a container;

FIG. 13 is a front view of an exemplary handle assembly, according to one example; and

FIGS. 14-16 each depict an exemplary handle assembly having at least one RFID tag incorporated in an exemplary location, according to one example.

### DETAILED DESCRIPTION OF THE INVENTION

Aspects of the invention are described herein with reference to storage assemblies comprising containers, such as a fluid container (e.g. water bottle). It will be understood by one of ordinary skill in the art that the example storage assemblies described herein may be used to store a variety of products, and are not limited to any product disclosed herein. As used herein, the term “container” comprises an enclosure or apparatus defining an interior space which can contain a fluid, e.g. water or other drinking liquids, other consumer items (e.g. foods, solids, objects, etc.), or other articles. In an exemplary embodiment, a container may be a water bottle.

Further, as used herein, the term “radio frequency identification”, or RFID, is a generic term for technologies that use radio waves to identify and/or track items or articles, such as storage assemblies. One skilled in the art would understand from the description herein that identification and/or tracking is made possible by storing at least a unique identifier in connection with the container (and/or additional information relating to the container or contents therein) on a microchip that is attached to an antenna. The microchip and the antenna together form an exemplary RFID tag. The antenna enables the microchip to transmit the identifier and other information to an RFID reader. The RFID reader then converts the radio waves reflected back from the RFID tag into digital information that can then be processed by an electronic device (e.g. computer). In a non-limiting example, RFID tag may include an “active” RFID tag having a transmitter and an integrated power source (e.g. a battery) to run the microchip's circuitry and to broadcast a signal to an RFID reader. In another non-limiting example, RFID tag may include a “passive” RFID tag which draw power from the RFID reader. In another non-limiting example, RFID tag may include a “semi-passive” RFID tag, which utilizes both an integrated power source and power from the RFID reader. Any of the foregoing examples of RFID tags may be used in the storage assemblies discussed herein.

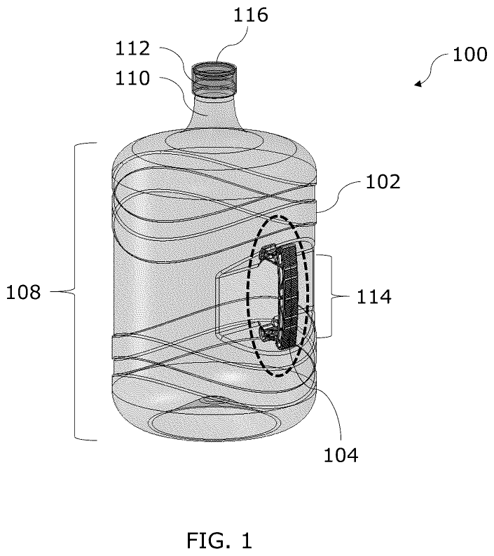

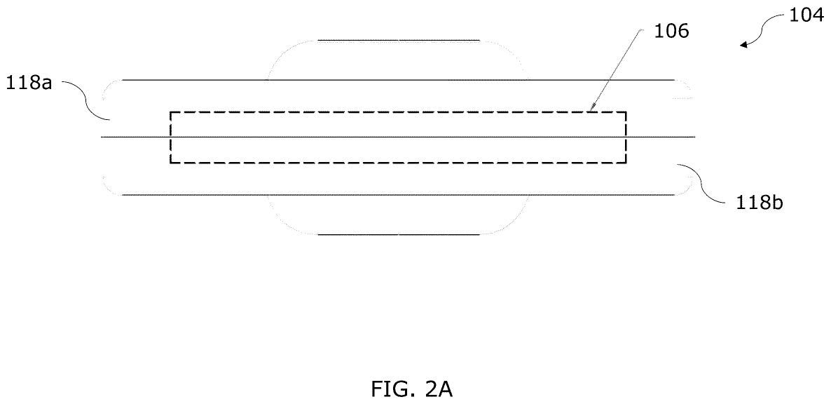

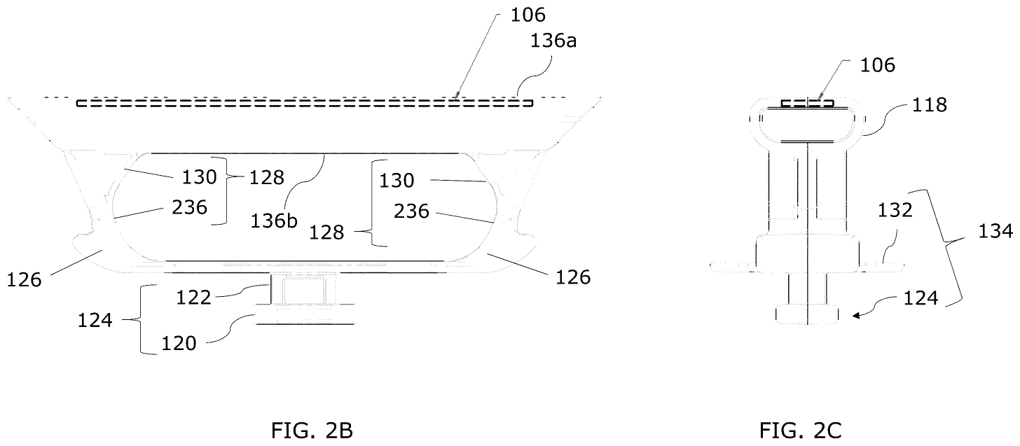

With reference to the drawings, FIG. 1 shows an exemplary storage assembly. The storage assembly, such as storage assembly 100. Generally, storage assembly 100 assembly comprises a container 102, a handle assembly or handle 104, and at least one electronic component 106 (FIG. 2A) configured for at least wireless identification or tracking of the container 102. Individual components of storage assembly 100 will now be described in detail below.

Container 102 may have a size and shape, depending on the contents to be contained, housed, or secured within. As shown in FIG. 1, container 102 may comprise a water bottle, with a generally cylindrical body 108, a neck 110, a mouth 112, and an attachment surface 114. Handle 104 may be positionable adjacent or against attachment surface 114, for mounting the handle 104 to the container 102 via the attachment surface 114. One skilled in the art would understand from the description herein that although the figures (e.g. FIG. 1) illustrate attachment surface 114 being disposed adjacent or on the body 108 of container 102, the location of attachment surface 114 may vary, according to functional or aesthetic considerations. For example, attachment surface 114 may be disposed in another location adjacent or on the body 108, or may be disposed around other portions of container 102, such as neck 110, mouth 112, or a combination thereof.

Container 102 may also have a closure 116 over an opening, such as mouth 112. Likewise, handle 104 may have a size and shape, depending on the container 102 on which the handle 104 may be mounted. In an exemplary embodiment, handle 104 may have a different size or shape from that of container 102. A person of ordinary skill in the art will understand from the description herein that although FIG. 1 depicts container 102 as a water bottle, storage system 100 may include other containers 102 having different sizes and shapes, without departing from the scope of the invention. One skilled in the art would also understand that containers 102 and handle 104 may be formed of unitary construction, or may be formed as separate components and coupled together by known attachment means, such as hook-and-loop fasteners, adhesives, or double-sided tape, or combinations thereof. Other suitable fastening and attachment mechanisms will be known to one of ordinary skill in the art from the description herein.

Additionally or optionally, at least handle 104 comprises reusable materials, such that handle 104 may be utilized in connection with one or more containers 102, prior to ultimate disposal or replacement. Container 102 may also comprise reusable materials, or handle 104 may comprise different materials of construction than container 102. Still further, container 102 may comprise food contact safe or sufficiently inert material and/or material that exhibits little to no corrosion associated with presence of or contact with water within container 102, when container 102 is a fluid container (e.g. water bottle). One skilled in the art would understand from the description herein that reusable materials may comprise recyclable component such as known biodegradable plastic, glass, or metal material. Further, a reusable handle 104 and/or container 102 would lead to a reduction in cost or overall improvement in manufacture of storage assemblies.

As shown in at least FIGS. 2A-2C, in an exemplary embodiment, handle 104 includes at least an elongated grip portion 118 and additionally or optionally, an anchor 134 for mounting the handle 104 to the attachment surface 114 of container 102. One skilled in the art would understand that grip portion 118 and anchor 134 may be formed of unitary construction, or may be formed as separate components and coupled together by known attachment means, such as adhesives, hook-and-loop fasteners, adhesives, or double-sided tape, or combinations thereof. Other suitable fastening and attachment mechanisms will be known to one of ordinary skill in the art from the description herein. When handle 104 comprises only an elongated grip portion 118, one skilled in the art would understand from the description herein that handle 104 having grip portion 118 may be mounted to attachment surface 114 of container 102. In this configuration, handle 104 may comprise a wire handle, which may be manipulated to provide a grip portion 118 and another portion to be mounted to the attachment surface 114 of container 102, without requiring another component.

Elongated grip portion 118 extends from a first end 118a to second end 118b. Generally, grip portion 118 may have a uniform or smooth surface, or may have an uneven surface to include grips, ridges, or raised surfaces to facilitate easier grasp of storage system 100 by a user, or for aesthetic considerations. The uneven surface may extend throughout the entirety of grip portion 118, or may be present in portions thereof, e.g. central portion between first end 118a and second end 118b. Additionally or optionally, as shown in FIG. 1, the grip portion 118 comprises, when the handle 104 is coupled to the container 102, an outer surface 136a facing outwardly away from the container 102, and an inner surface 136b facing inwardly toward the container 102. Likewise, outer surface 136a and/or inner surface 136b may have a uniform or smooth surface, or may have an uneven surface to include grips, ridges, or raised surfaces to facilitate easier grasp of storage system 100 by a user, or for aesthetic considerations. The uneven surface may extend throughout the entirety of outer surface 136a and/or inner surface 136b or may be present in portions thereof.

Still further, handle 104 may include at least one leg 128 extends from the grip portion 118. In an exemplary embodiment, leg 128 extends from first end 118a and another leg 128 extends from second end 118b. Each of the one or more legs 128 may have a grip end 130 and a foot end 236 opposite the grip end 130. The handle 104 may also include a foot 126 attached to each foot end 236. Although the handle 104 is illustrated in at least FIGS. 2A-2C as having two legs 128, one skilled in the art would understand from the description herein that handle 104 may have a plurality of legs 128, or alternatively, may be formed in unitary construction with grip portion 118 or another component of handle 104.

As indicated above, handle 104 includes anchor 134 for mounting the handle 104 to the attachment surface 114 of container 102. Anchor 134 is configured to be coupled to at least one foot end 236. In an exemplary embodiment, the anchor 134 comprises a base 132 extending along a base direction that is parallel to the elongated grip portion 118. Anchor 134 may additionally or optionally, include a protrusion 124 extending away from the base 132 and in a protrusion direction that is perpendicular to the base direction 132. In an exemplary embodiment, the protrusion 124 comprises an upper section 122 and a lower section 120. One skilled in the art would understand that upper section 122 and lower section 120 may be formed of unitary construction, or may be formed as separate components and coupled together by known attachment means. Similarly, protrusion 124 and base 132 may be formed of unitary construction, or may be formed as separate components and coupled together by known attachment means. Likewise, anchor 134 and at least one foot end 236 may be formed of unitary construction, or may be formed as separate components and coupled together by known attachment means. Still further, as with the other components of handle 104, one or more of base 132 and protrusion 124 may have a uniform or smooth surface, or may have an uneven surface to include grips, ridges, or raised surfaces to facilitate attachment to container 102 via attachment surface 114, or for aesthetic considerations. The uneven surface may extend throughout the entirety of one or more of base 132 and protrusion 124, or may be present in portions thereof.

Further, storage assembly 100 comprises at least one electronic component 106. The at least one electronic component 106 may be configured for at least wireless identification or tracking of the container 102. In an exemplary embodiment, the at least one electronic component 106 comprises at least one RFID tag. Additionally or optionally, the at least one electronic component 106 may be partially or entirely encapsulated in the handle 104.

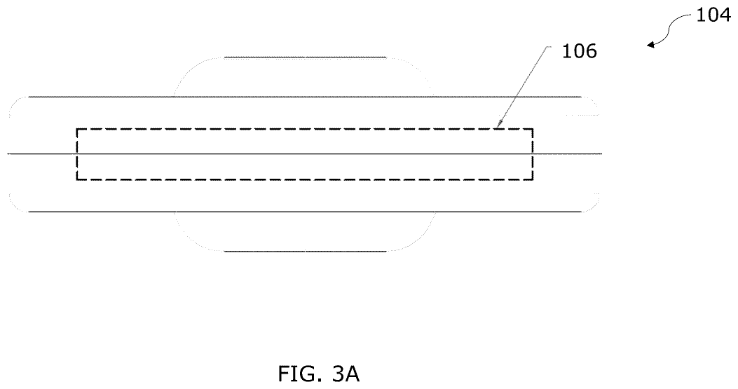

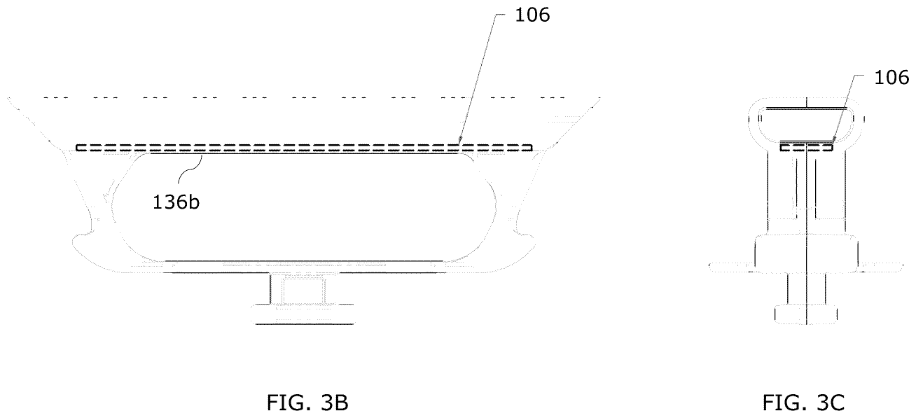

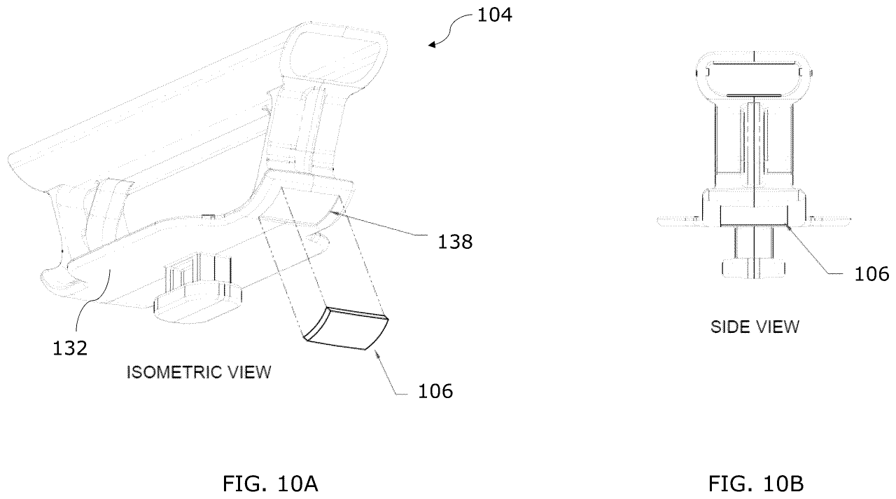

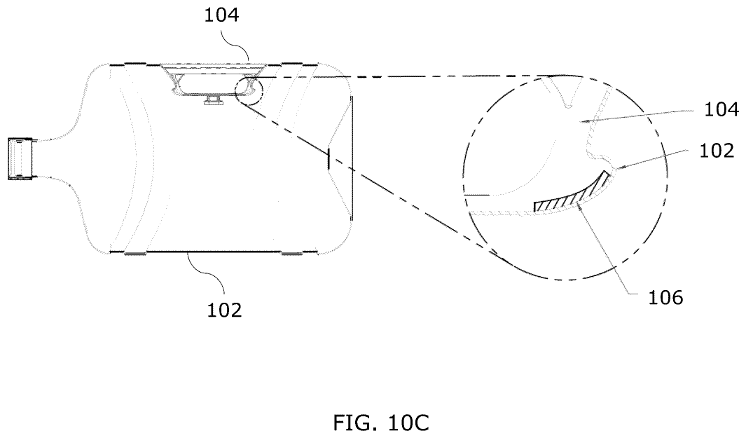

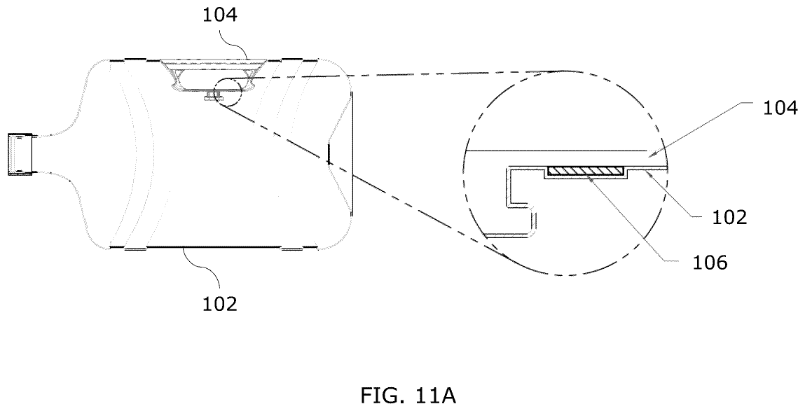

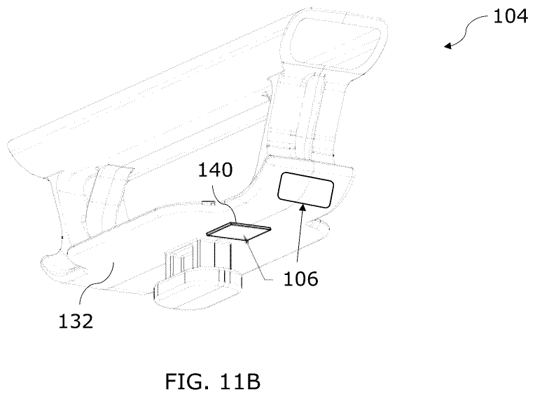

In particular, although FIGS. 2A-2C, FIGS. 3A-3C, FIGS. 4A-4C, FIGS. 5A-5C, FIGS. 6A-6C, FIGS. 7A-7C, FIGS. 8A-8C, FIGS. 9A-9B FIGS. 10A-10C, and FIGS. 11A-11B show exemplary locations of the at least one electronic component 106, one skilled in the art would understand from the description herein that these exemplary locations are for illustrative purposes only, and are not intended to be limiting. As illustrated in FIGS. 2A-2C, the at least one electronic component 106 may be disposed along or within the outer surface 136a of grip portion 118. Additionally or optionally, as illustrated in FIGS. 3A-3C, the at least one electronic component 106 may be disposed along or within the inner surface 136b of grip portion 118.

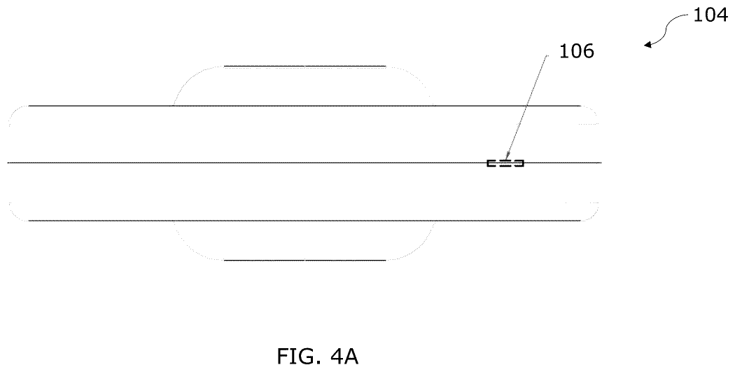

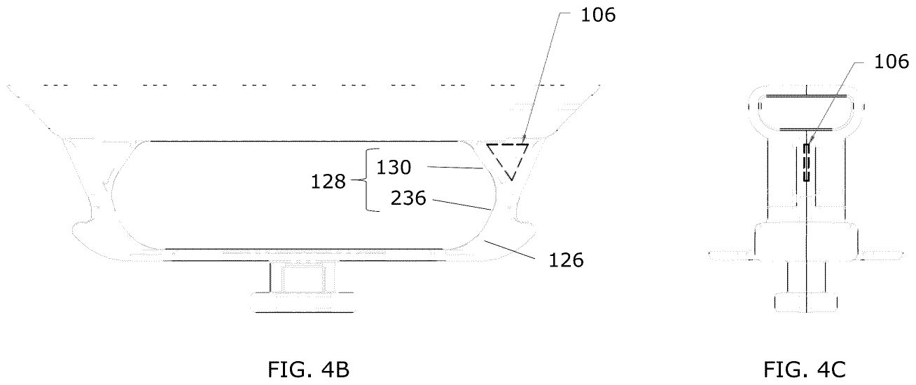

Additionally or optionally, as illustrated in FIGS. 4A-4C, the at least one electronic component 106 may be disposed along or within at least one leg 128 of handle 104. In an exemplary embodiment, the at least one electronic component 106 may be disposed within the grip end 130 of handle 104. At least one electronic component 106 may be additionally or optionally disposed in the other leg 128 of handle 104.

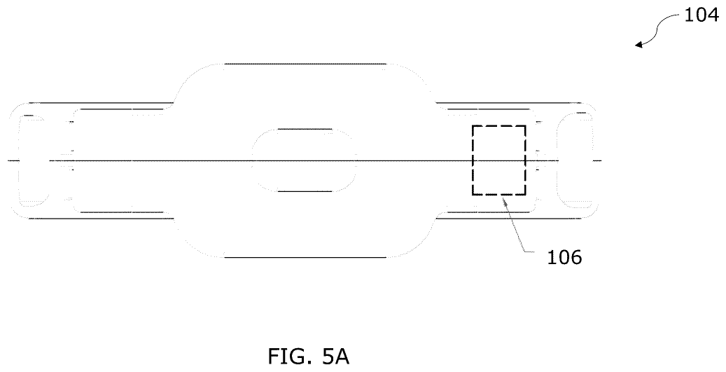

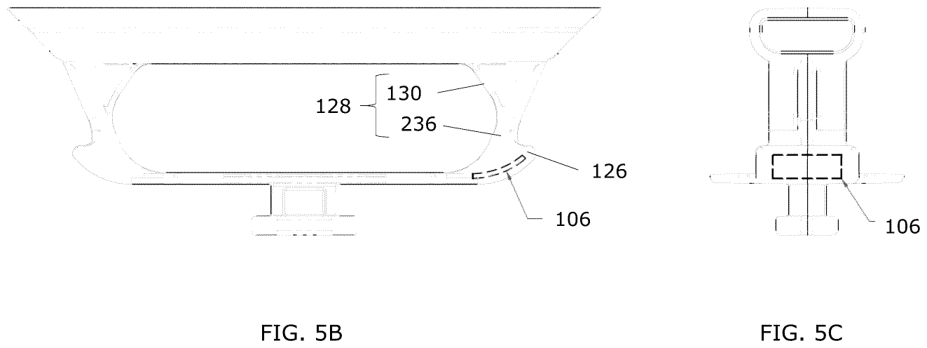

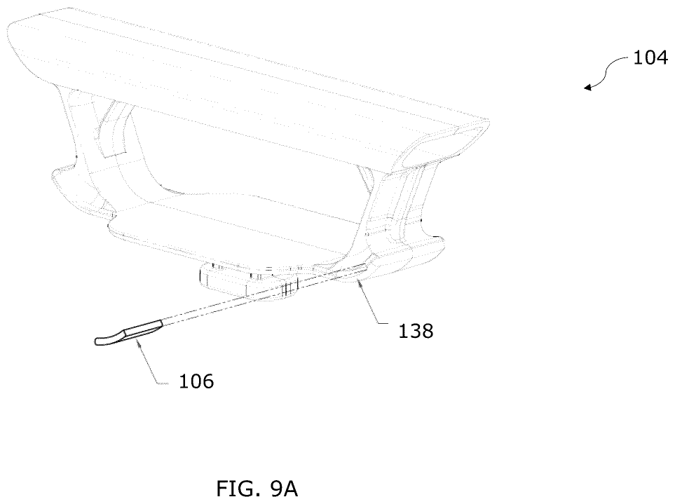

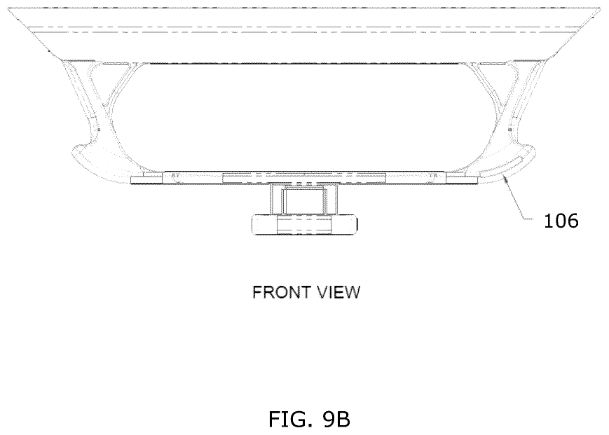

Additionally or optionally, as illustrated in FIGS. 5A-5C, the at least one electronic component 106 may be disposed along or within at least one foot 126 of handle 104. At least one electronic component 106 may be additionally or optionally disposed in the other foot 126 of handle 104. In an exemplary embodiment, as shown in FIGS. 9A-9B and 10A-10C, the at least one electronic component 106 may be disposed within the foot 126, and foot 126 includes an opening 138. Opening 138 is configured to receive the at least one electronic component 106. In one non-limiting example, opening 138 may comprise a cavity, such as a molded cavity formed in foot 126. In another non-limiting example, opening 138 may comprise a recess, such as a molded recess formed at a bottom surface of foot 125. The cavity or recess 138 may be adapted for at least partially enclosing the at least one electronic component 106 within the foot 126. Likewise, at least one electronic component 106 may be additionally or optionally disposed in the other foot 126 having another opening 138.

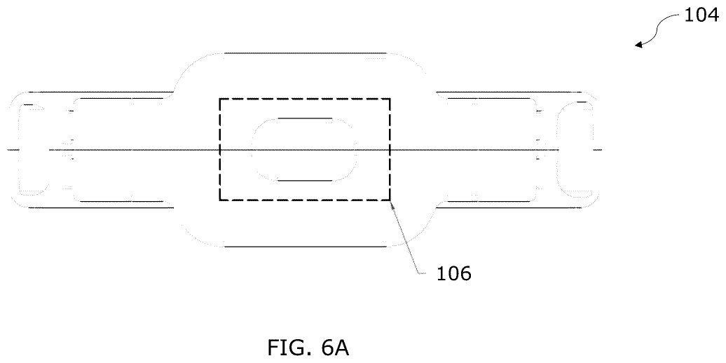

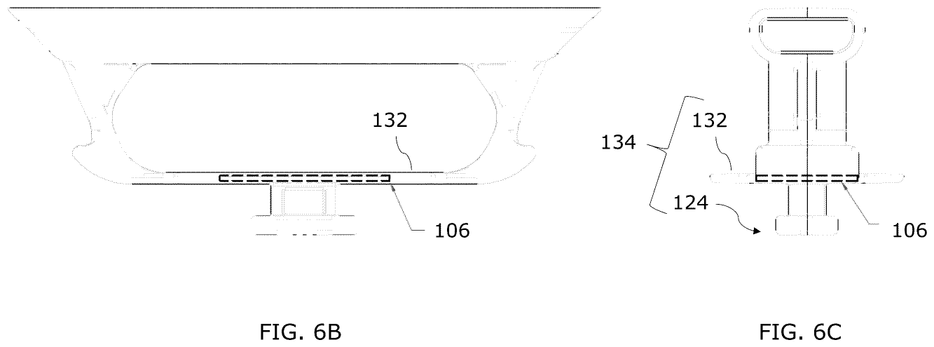

Additionally or optionally, as illustrated in FIGS. 6A-6C, the at least one electronic component 106 may be disposed along or within base 132 of anchor 134 of handle 104. In an exemplary embodiment, as shown in FIGS. 11A-11B, the at least one electronic component 106 may be disposed within the base 132 and/or foot 126, such that base 132 and/or foot 126 includes a respective opening 140. Opening 140 may be a molded recess formed at a bottom surface of base 132 or a bottom surface of foot 126. The opening 140 may be adapted for at least partially enclosing the at least one electronic component 106 within the base 132 and/or foot 126. Likewise, at least one electronic component 106 may be additionally or optionally disposed in portions of base 132 having opening 140 (other than what is illustrated in FIGS. 11A-11B). In an exemplary embodiment, the handle 104 is mounted to the container 102, by blow molding the material of container 102 over a portion of the handle 104, including but not limited to, foot 126 containing at least one electronic component 106 received in respective opening 140, base 132 containing at least one electronic component 106 received in respective opening 140, or combination thereof. In this way, material of container 102 is molded over a portion of the handle 104 after the at least one electronic component 106 is placed in opening 140 of handle 104 so that the at least one electronic component 106 is encapsulated by material from handle 104 and/or container 102.

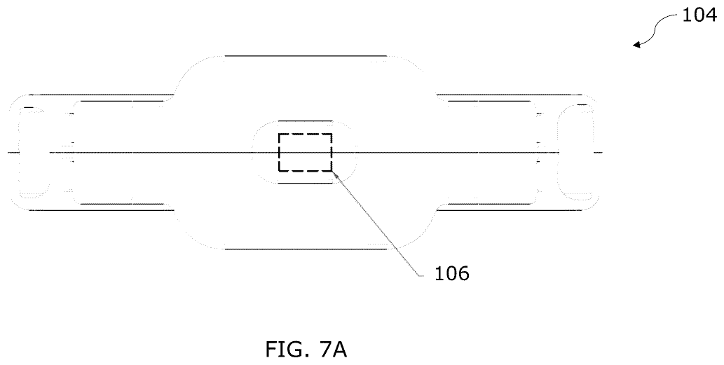

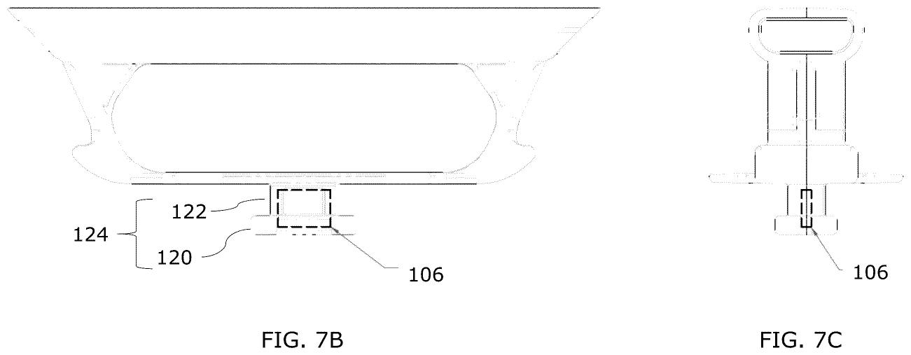

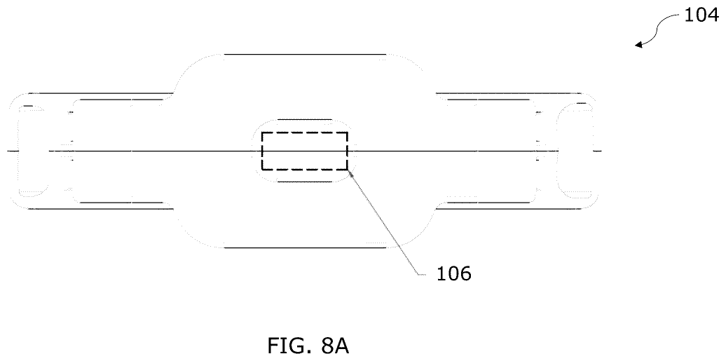

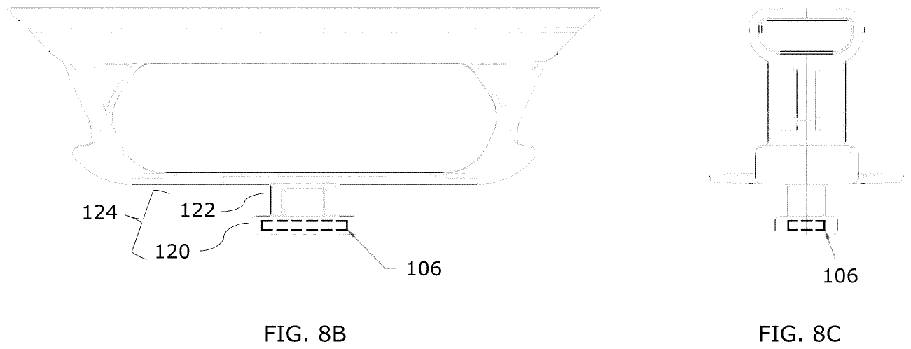

Additionally or optionally, as illustrated in FIGS. 7A-7C, the at least one electronic component 106 may be disposed along or within protrusion 124 of anchor 134 of handle 104. In an exemplary embodiment, as shown in FIGS. 8A-8C, the at least one electronic component 106 may be disposed within the lower section 120 of protrusion 124. At least one electronic component 106 may be additionally or optionally disposed in upper portion 122 of protrusion 124.

In any of the configurations discussed above, in which the at least one electronic component 106 is fully encapsulated within a portion of handle 104 (or component of handle assembly 104), the encapsulation helps maintain the integrity and operability of the electronic component 106 as well as protect the electronic component 106 from adverse environmental conditions or contaminants. Specifically, this encapsulation can aid in the reusability of the handle 104 and/or container 102, by maintaining or promoting repeated use or longevity in each use cycle of handle 104 with container 102.

Advantageously, the use of RFID technology permits ease of identification and tracking of at least container 102, because the at least one RFID tag 106 may incorporate an identifier unique to the container 102 as well as additional useful data, including but not limited to, tracking information (e.g. during distribution, transport, and end-use handling, etc. of container 102), manufacturer information, and product data. In a non-limiting example, a manufacturer of storage assemblies 100 can gather data about the storage assemblies 100 by reading respective RFID tags at different stages of the manufacturing process, e.g. as storage assembly 100 moves throughout the facility. In another non-limiting example, the storage assembly 100 and date related thereto can be tracked and processed at different stages of the use cycle or product life. The data can then be stored, received, and processed to perform quantitative or qualitative analysis of container 102, including quantifying usable life of container or product 102. This is beneficial, for example, over a bar code label that is limited to indicia directed to a single unique identifier for storage assembly 100, whereas an RFID tag can support a larger data set. Still further, the use of RFID tags (or other electronic component(s) with similar ID and/or tracking capabilities), in conjunction with RFID reader based systems, can allow identification and/or tracking from a distance and/or without human assistance, of different RFID tags associated with a plurality of storage assemblies 100 located in the same area.

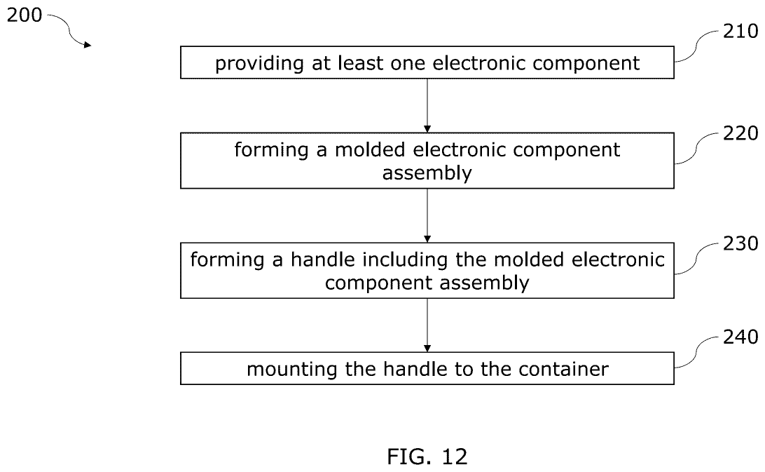

Referring now to FIG. 12, a method 200 of integrating an electronic component to a handle provided for attachment to a container is provided. The method 200 generally includes steps of providing at least one electronic component, forming a molded electronic component assembly, forming a handle including the molded electronic component assembly, and mounting the handle to the container Additional details of method 200 are set forth below with respect to the elements of storage assembly 100.

In step 210, at least one electronic component is provided. In particular, the at least one electronic component may comprise at least one RFID tag.

In step 220, a molded electronic component assembly is formed. Specifically, the at least one electronic component 106 is formed by molding a molding material about the at least one electronic component 106. In a non-limiting example, the molding material is molded about the at least one RFID tag 106, such that the molding material covers at least a portion of a surface of the at least one RFID tag 106. In this step, the at least one RFID tag 106 may be partially or completely encapsulated. Additionally or optionally, the molding material may be selected for bonding with a material of a handle, such as the handle 104.

In step 230, a handle including the molded electronic component assembly is formed. In particular, handle 104 is provided with the molded electronic component assembly embedded therein or mounted thereon. In an exemplary embodiment, step 230 comprises forming an opening, such as opening 138, 140 in the handle 104 and step 210 comprises providing the at least one electronic component 106 by inserting the at least one RFID tag 106 into the opening 138, 140 of the handle 104. Additionally or optionally, step 220 comprises flowing the molding material into the opening 138, 140 of the handle 104 and forming the molding material over one or more exposed surfaces of the at least one RFID tag 106 disposed in the opening 138, 140 of the handle 104.

In step 240, the handle is mounted to the container. In an exemplary embodiment, the handle 104 is mounted to the container 102, by blow molding the material of container 102 over a portion of the handle 104, including but not limited to, as foot 126, anchor 134, legs 128, or combination thereof. In one non-limiting example, step 220 may occur before step 240, such that the material of container 102 is molded over a portion of the handle 104 after the at least one RFID tag 106 is placed in opening 138, 140 of handle 104. In this way, the at least one RFID tag 106 is encapsulated by material from handle 104 and/or container 102.

In an exemplary embodiment, step 210 comprises providing the at least one electronic component 106 by adhering the at least one RFID tag 106 to a film. The film may generally be a thin, generally flexible sheet, of plastic. Step 220 comprises placing the film with the at least one RFID tag 106 in a mold prior to injecting the molding material into the mold. Additionally or optionally, step 220 comprises electrostatic pinning of the film with the at least one RFID tag 106 to a surface of the mold prior to injecting the molding material into the mold.

In another exemplary embodiment, step 210 comprises providing the at least one electronic component 106 by printing the at least one RFID tag 106 onto an in-mold decorating (IMD) surface. Step 220 comprises placing the IMD surface with the at least one RFID tag 106 in a mold prior to injecting the molding material into the mold.

Additionally or optionally, method 200 may further comprise step 250 of embedding the at least one electronic component 106, such as the at least one RFID tag 106, within the handle 104. In an exemplary embodiment, step 250 includes inserting a completely encapsulated RFID tag 106 into a housing and inserting the housing with the completely encapsulated RFID tag 106 into the handle 104. In a non-limiting example, to facilitate inserting a completely encapsulated RFID tag 106 into the handle 104, step 220 occurs prior to step 250.

Additionally or optionally, method 200 may further comprise step 260 of forming a plurality of guiding features for positioning the at least one RFID tag 106 in a mold. In particular, the guiding features are configured to detach from the at least one RFID tag 106, when the at least one RFID tag 106 is subjected to heat and/or pressure. Additionally or optionally, method 200 may further comprise step 270 of providing a plurality of support pins for supporting the at least one RFID tag 106 in a mold. In an exemplary embodiment, the support pins are configured to detach from the at least one RFID tag 106 when the at least one RFID tag 106 is subjected to heat and/or pressure.

Still further, one skilled in the art would understand from the description therein that the at least one electronic component 106 may be fixedly attached to the handle 104 or container 102 by additional known means, such as by one of a snap fit, an inlay, co-molded, adhesion, lamination, tape, a press fit, or a combination thereof.

FIG. 12 depicts an example method comprising steps that are performed sequentially in the order recited. However, it should be understood from the description herein that one or more steps may be omitted and/or performed out of the described sequence of the process while still achieving the desired result. Further, although the steps of method 200 are described with reference to the at least one RFID tag 106, one skilled in the art would understand from the description herein that the step may be applicable to other electronic components 106, including, but not limited, to at least one electronic component configured for at least wireless identification or tracking of the container 102.

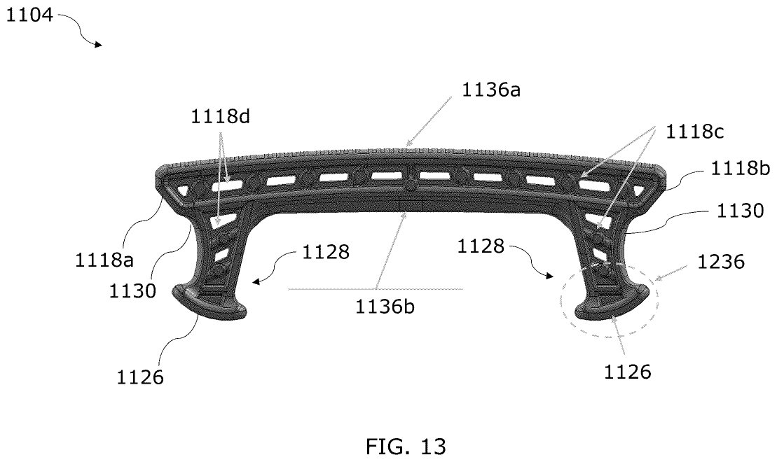

A second embodiment of an exemplary handle or handle assembly, such as handle assembly 1104, is depicted in FIGS. 13-16. Handle or handle assembly 1104 is generally similar to the details of handle or handle assembly 104, as described above, but differs in some respects. As shown in FIG. 13, handle 1104 includes at least an elongated grip portion 1118 extending from a first end 1118a to second end 1118b. Additionally or optionally, the grip portion 1118 comprises, when the handle 1104 is coupled to a container, such as container 102, an outer surface 1136a facing outwardly away from the container 102, and an inner surface 1136b facing inwardly toward the container 102.

Still further, handle 1104 may include at least one leg 1128 extending from the grip portion 1118. In an exemplary embodiment, leg 1128 extends from first end 1118a and another leg 1128 extends from second end 1118b. Each of the one or more legs 1128 may have a grip end 1130 and a foot end 1236 opposite the grip end 1130. The handle 1104 may also include a foot 1126 attached to each foot end 1236. In a non-limiting example, the grip portion 1118 and one or more legs 1128 together form a center spine wall 1118c and the center spine wall 1118c comprise a plurality of spaced openings or windows 1118d.

Although the handle 1104 is illustrated in at least FIG. 13 as having two legs 1128, one skilled in the art would understand from the description herein that handle 1104 may have a plurality of legs 1128, or alternatively, may be formed in unitary construction with grip portion 1118 or another component of handle 1104. Moreover, the one or more legs 1128 of handle 1104 are configured for mounting the handle 1104 to an attachment surface, such as attachment surface 114 of container 102.

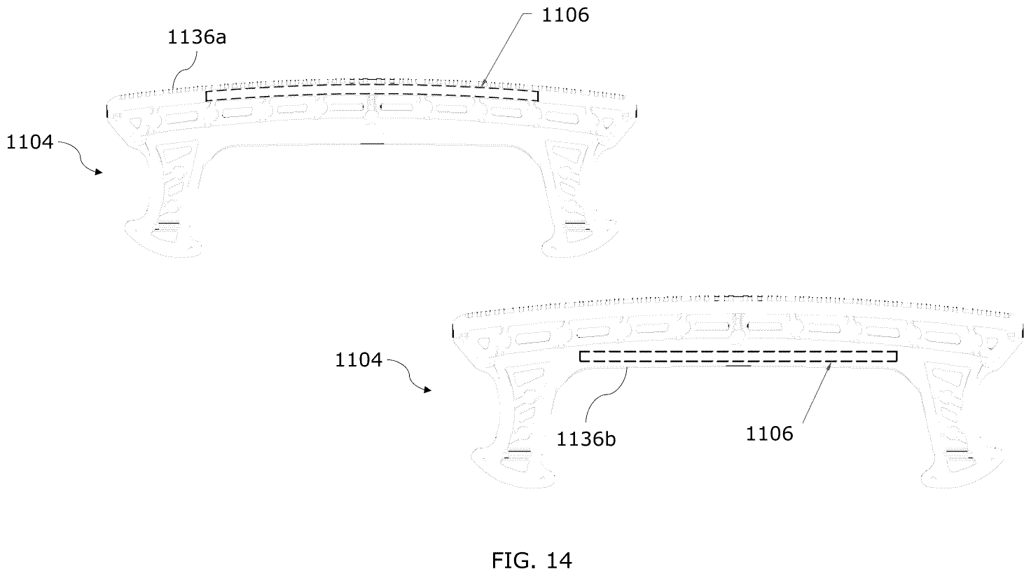

Further, as shown in FIGS. 14-16, handle 1104 comprises at least one electronic component, such as electronic component 1106. The at least one electronic component 1106 may be configured for at least wireless identification or tracking of the container 102 to which handle 1104 is attached. In an exemplary embodiment, the at least one electronic component 1106 comprises at least one RFID tag. Additionally or optionally, the at least one electronic component 1106 may be partially or entirely encapsulated in the handle 1104.

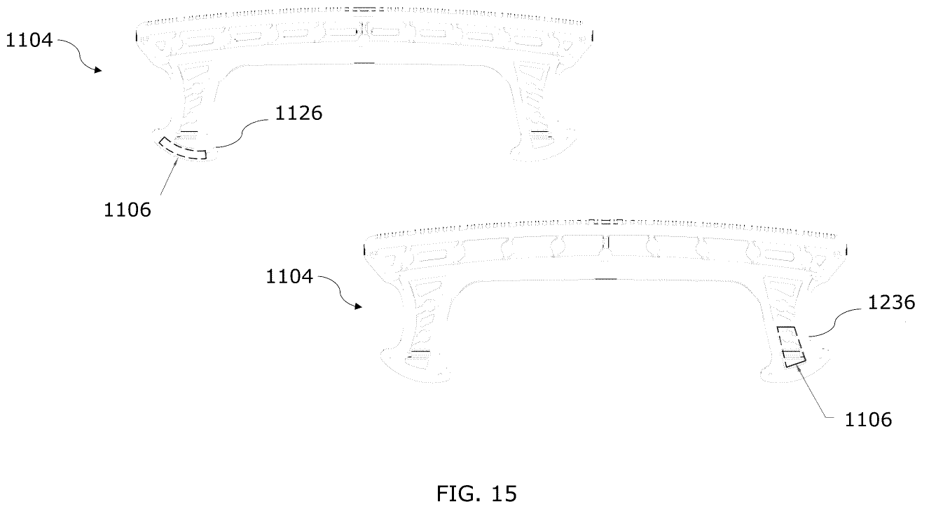

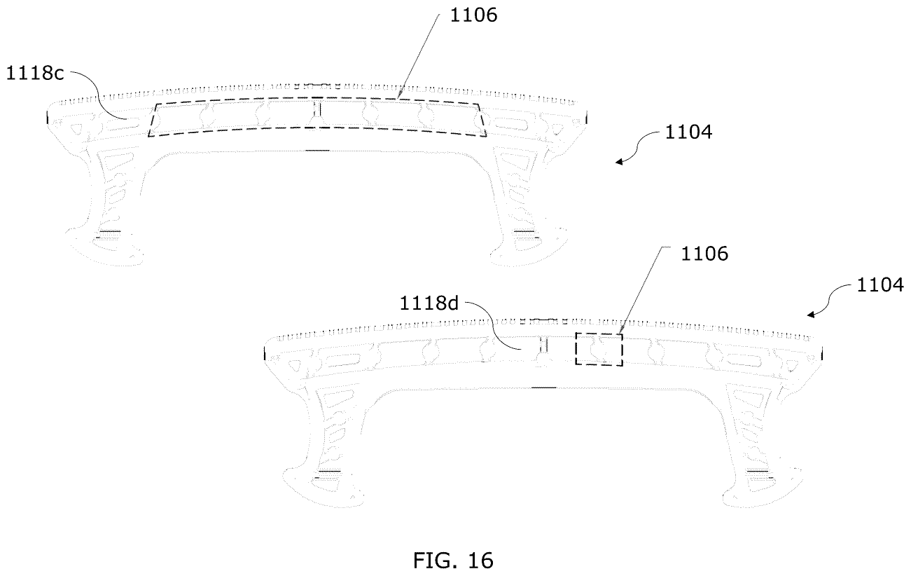

In particular, although FIGS. 14-16 show exemplary locations of the at least one electronic component 1106, one skilled in the art would understand from the description herein that these exemplary locations are for illustrative purposes only, and are not intended to be limiting. As illustrated in FIG. 14, the at least one electronic component 1106 may be disposed along or within the outer surface 1136a and/or inner surface 1136b of grip portion 1118. Additionally or optionally, as illustrated in FIG. 15, the at least one electronic component 1106 may be disposed along or within the respective foot ends 1236 and/or respective feet 1126. Additionally or optionally, as illustrated in FIG. 16, the at least one electronic component 1106 may be disposed along or within portions of the grip portion 1118, such as center spine wall 1118c or adjacent spaced openings 1118d. The location of the electronic component 1106 in or on the handle 1104 may be configured to (1) reduce or prevent instances of damage due to rough handling of at least handle 1104; (2) reduce or prevent compromising the structural integrity, aesthetics, and cleanability of at least the handle 1104; and (3) retain the electronic component 1106 as entirely encapsulated and inaccessible to user's hands and other external abrasive surfaces.

Although the invention is illustrated and described herein with reference to specific embodiments, the invention is not intended to be limited to the details shown. Rather, various modifications may be made in the details within the scope and range of equivalents of the claims. Additionally, variations, changes and substitutions among the different embodiments discussed above may fall within the spirit and scope of the invention. Accordingly, it is intended that the appended claims cover all such variations as fall within the spirit and scope of the invention.

What is claimed:

1. A storage assembly comprising:
a container having an attachment surface;
a handle positionable adjacent the attachment surface, the handle comprising:
an elongated grip portion,
an anchor for mounting the handle to the attachment surface, and
at least one electronic component configured for wireless identification or tracking of the container, the at least one electronic component encapsulated partially or entirely in the handle.

2. The storage assembly of claim 1, wherein the at least one electronic component comprises at least one radio frequency identification device (RFID) tag.

3. The storage assembly of claim 1, wherein the handle includes one or more legs extending from the grip portion, each of the one or more legs having a grip end and a foot end opposite the grip end.

4. The storage assembly of claim 3, wherein the handle includes a foot attached to each foot end.

5. The storage assembly of claim 4, wherein the anchor is coupled to at least one foot end.

6. The storage assembly of claim 1, wherein the anchor comprises a base extending along a base direction that is parallel to the elongated grip portion, and a protrusion extending away from the base and in a protrusion direction that is perpendicular to the base direction.

7. The storage assembly of claim 1, wherein the container comprises a fluid container.

8. The storage assembly of claim 1, wherein the grip portion comprises, when the handle is coupled to the container, an outer surface facing outwardly away from the container, and an inner surface facing inwardly toward the container.

9. The storage assembly of claim 4, wherein the at least one RFID tag is disposed along the inner surface of the grip portion.

10. The storage assembly of claim 3, wherein the at least one RFID tag is disposed in the one or more legs.

11. The storage assembly of claim 4, wherein the at least one RFID tag is disposed in the foot.

12. The storage assembly of claim 6, wherein the at least one RFID tag is disposed in the base.

13. The storage assembly of claim 1, wherein the at least one RFID tag is disposed in the anchor.

14. The storage assembly of claim 11, wherein the foot includes an opening configured to receive the at least one RFID tag.

15. The storage assembly of claim 14, wherein the opening comprises a cavity for at least partially enclosing the at least one RFID tag within the foot.

16. The storage assembly of claim 14, wherein the opening comprises a recess formed along a bottom surface of the foot.

17. The storage assembly of claim 13, wherein the protrusion comprises an upper section and a lower section, and the at least one RFID tag is disposed in the upper section or the lower section.

18. The storage assembly of claim 1, wherein at least one of the container and the handle is reusable, and the anchor is configured for removably mounting the handle to the attachment surface.

19. A handle assembly configured to be coupled to a container having an attachment surface, the handle assembly comprising:
an elongated grip portion;
an anchor for removably mounting the handle assembly to the attachment surface of the container; and
at least one electronic component configured for wireless identification or tracking of the container, the at least one electronic component being encapsulated partially or completely in the handle assembly.

20. The handle assembly of claim 19, wherein the at least one electronic component comprises at least one radio frequency identification device (RFID) tag.

21. The handle assembly of claim 19, further comprising one or more legs extending from the grip portion, each of the one or more legs having a grip end and a foot end opposite the grip end.

22. The handle assembly of claim 20, further comprising a foot attached to each foot end.

23. The handle assembly of claim 21, wherein the anchor comprises a base extending along a base direction that is parallel to the elongated grip portion, and a protrusion extending away from the base and in a protrusion direction that is perpendicular to the base direction.

24. The handle assembly of claim 19, wherein the anchor is coupled to at least one foot end.

25. The handle assembly of claim 19, wherein the container comprises fluid container.

26. The handle assembly of claim 19, wherein the grip portion, when the handle assembly is coupled to the container, an outer surface facing outwardly away from the container and an inner surface facing inwardly toward the container.

27. The handle assembly of claim 25, wherein the at least one RFID tag is disposed along the inner surface of the grip portion.

28. The handle assembly of claim 20, wherein the at least one RFID tag is disposed in the one or more legs.

29. The handle assembly of claim 21, wherein the at least one RFID tag is disposed in the foot.

30. The handle assembly of claim 22, wherein the at least one RFID tag is disposed in the base.

31. The handle assembly of claim 19, wherein the at least one RFID tag is disposed in the anchor.

32. The handle assembly of claim 28, wherein the foot includes an opening configured to receive the at least one RFID tag.

33. The handle assembly of claim 31, wherein the opening comprises a cavity for at least partially enclosing the at least one RFID tag within the foot.

34. The handle assembly of claim 31, wherein the opening comprises a recess formed along a bottom surface of the foot.

35. The handle assembly of claim 19, wherein the anchor comprises an upper section and a lower section, and the at least one RFID tag is disposed in the upper section or the lower section.

36. The handle assembly of claim 19, wherein the elongated grip portion comprises a wire handle.

37. A method of integrating an electronic component to a handle provided for attachment to a container, the electronic component configured for at least wireless identification or tracking of the container, the method comprising:
(a) providing at least one electronic component;
(b) molding a molding material about the at least one electronic component to form a molded electronic component assembly;
(c) forming a handle including the molded electronic component assembly; and
(d) mounting the handle to the container.

38. The method of claim 37, wherein the at least one electronic component comprises at least one RFID tag.

39. The method of claim 38, wherein step (b) comprises molding the molding material about the at least one RFID tag, such that the molding material covers at least a portion of a surface of the at least one RFID tag.

40. The method of claim 38, wherein the molding material is selected for bonding with a material of the handle.

41. The method of claim 38, further comprising (e) embedding the at least one RFID tag within the handle.

42. The method of claim 41, wherein step (e) comprises inserting a completely encapsulated RFID tag into a housing and inserting the housing with the completely encapsulated RFID tag into the handle.

43. The method of claim 38, wherein step (a) comprises adhering the at least one RFID tag to a film.

44. The method of claim 43, wherein step (b) comprises placing the film with the at least one RFID tag in a mold prior to injecting the molding material into the mold.

45. The method of claim 38, wherein step (a) comprises printing the at least one RFID tag onto an in-mold decorating (IMD) surface.

46. The method of claim 45, wherein step (b) comprises placing the IMD surface with the at least one RFID tag in a mold prior to injecting the molding material into the mold.

47. The method of claim 38, wherein step (c) comprises forming an opening in the handle and step (a) comprises inserting the at least one RFID tag into the opening of the handle.

48. The method of claim 47, wherein step (b) comprises flowing the molding material into the opening of the handle and forming the molding material over one or more exposed surfaces of the at least one RFID tag disposed in the opening of the handle.

49. The method of claim 41, wherein step (b) occurs prior to step (e), such that at least one encapsulated RFID tag is embedded within the handle.

50. The method of claim 38, further comprising (f) forming a plurality of guiding features for positioning the at least one RFID tag in a mold, the guiding features configured to detach from the at least one RFID tag when the at least one RFID tag is subjected to heat or pressure.

51. The method of claim 38, further comprising (g) providing a plurality of support pins for supporting the at least one RFID tag in a mold, the support pins configured to detach from the at least one RFID tag when the at least one RFID tag is subjected to heat or pressure.

52. The method of claim 43, wherein step (b) comprises electrostatic pinning of the film with the at least one RFID tag to a surface of the mold prior to injecting the molding material into the mold.

53. The method of claim 38, wherein the container comprises a fluid container.
